(19) United States
(12) Patent Application Publication
(10) Pub. No.: US 2018/0232753 A1
(43) Pub. Date: Aug. 16, 2018

(54) DYNAMIC DETERMINISTIC DWELL TIMES IN A VENUE

(71) Applicant: International Business Machines Corporation, Armonk, NY (US)

(72) Inventors: Michael R. Billau, Durham, NC (US); John K. Gerken, III, Apex, NC (US); Jeremy A. Greenberger, Raleigh, NC (US); Ciaran E. Hannigan, Morrisville, NC (US)

(21) Appl. No.: 15/432,391

(22) Filed: Feb. 14, 2017

(51) Int. Cl. G06Q 30/02

(52) U.S. Cl. CPC G06Q 30/0205

(57) ABSTRACT

Embodiments of the present invention provide a method, system and computer program product for dynamically determining dwell times in a zone of a retail setting. In an embodiment of the invention, a method for dynamically determining dwell times in a zone of a retail setting includes defining different zones of a retail setting in memory of a host computing system and establishing a different dwell time for each of the different zones. The method additionally includes observing footfall in each of the different zones for different individuals in order to compute an actual dwell time for each individual in a particular one of the different zones. Finally, the method includes re-establishing the different dwell time for each of the different zones based upon the observed footfall.

### BACKGROUND OF THE INVENTION

### Field of the Invention

The present invention relates to dwell time processing and more particularly to processing dwell time metrics in a physical space.

Dwell time is a metric often used in the context of search engine optimization that calculates user engagement and Web session duration. Generally speaking, dwell time is a metric not readily accessible, but affects nonetheless the search engine results of a search query. Oftentimes, the dwell time metric is reduced to mere session duration, namely the amount of time an end user views a Web page. But, dwell time is a more advanced concept that combines session duration and bounce rate, i.e. the rate at which end users leave a Web site after having viewed only a single Web page. While dwell time is a concept thoroughly understood in cyberspace, a different dwell time metric exists in physical space.

### BRIEF SUMMARY OF THE INVENTION

Embodiments of the present invention address customer path analysis and provide a novel and non-obvious method, system and computer program product for dynamically determining dwell times in a zone of a retail setting. In an embodiment of the invention, a method for dynamically determining dwell times in a zone of a retail setting includes defining different zones of a retail setting in memory of a host computing system and establishing a different dwell time for each of the different zones. The method additionally includes observing footfall in each of the different zones for different individuals in order to compute an actual dwell time for each individual in a particular one of the different zones. Finally, the method includes re-establishing the different dwell time for each of the different zones based upon the observed footfall.

In one aspect of the embodiment, the establishment of the different dwell time for each of the different zones includes computing the different dwell time for each of the different zones during a training process in which footfall is observed in each of the different zones for different individuals in order to compute an initial dwell time for each individual in a particular one of the different zones. In another aspect of the embodiment, the dwell time for a corresponding one of the different zones is established initially by combining a known minimum time required for an individual to traverse a corresponding one of the different zones, with a padding value that is a function of the minimum time. In yet another aspect of the embodiment, the minimum time is determined based upon a known distance from an entry point of the corresponding one of the zones to an exit point of the corresponding one of the zones divided by a specified preferred walking speed of an individual. Finally, in even yet another aspect of the embodiment, in response to a change by an operator in the host computing system of a location of the entry point and exit point of a corresponding one of the zones, the minimum time is re-determined.

In another embodiment of the invention, a data processing system is configured for dynamically determining dwell times in a zone of a retail setting. The system includes a host computing system with one or more computers, each with memory and at least one processor. The system also includes an array of footfall sensors coupled to the host computing system and disposed at different positions in different zones of a retail setting. Finally, the system includes a dynamic dwell time determination module executing in the memory of the host computing system. The module includes program code enabled upon execution to define the different zones of the retail setting in the memory of the host computing system, to establish a different dwell time for each of the different zones, to observe footfall in each of the different zones for different individuals in order to compute an actual dwell time for each individual in a particular one of the different zones, and to re-establish the different dwell time for each of the different zones based upon the observed footfall.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a process for dynamically determining dwell times in a zone of a retail setting;

FIG. 2 is a schematic illustration of a data processing system configured for dynamically determining dwell times in a zone of a retail setting; and,

FIG. 3 is a flow chart illustrating a process for dynamically determining dwell times in a zone of a retail setting.

### DETAILED DESCRIPTION OF THE INVENTION

Embodiments of the present invention recognize that, in physical space, dwell time is a metric important to proximity marketing and is essential to computing an optimal store layout of a retail setting based upon an observed customer path for different customers in the retail store. To wit, the vast majority of all retail sales occurs in the physical retail setting and thus, “footfall analysis” is an integral part of retail setting optimization. Footfall analysis generally includes sensing the presence and flow of different customers in the retail setting. The analysis then is used to generate a visual interpretation of the flow of customer traffic in a store, for example through the generation of heat maps of customer flow. The heat maps generated from the footfall analysis allows one analyzing store performance to consider a first zone of a store visited by a typical customer, popular paths taken by customers through the store, the number of repeat visits by a customer to a particular zone of the store, the relationship between different zones of a store and pairs of zones of a store between which customers transit, and dwell times in each zone.

In this regard, zone dwell times refers to the amount of time a customer is determined to have entered a particular zone of a store, and for how long the customer remains in the zone. It is well known to track zone dwell times in the retail setting and to trigger actions when the measured zone dwell times exceed a statically specified duration of time. Typical triggered actions include reconfiguring a layout of a zone, summoning a sales agent to a zone in which a customer dwells beyond the threshold time, or dynamically generating a coupon or other promotional offer for the benefit of a shopper determined to have remained in a particular zone of a store beyond a statically specified threshold time period.

Embodiments of the present invention additionally recognize that zones can be dynamically or manually specified, for instance by drawing a perimeter of the zone on a map using established software drawing techniques. Embodiments of the present invention recognize that the notion of dwell time, as previously stated, does not encompass or provide the information that the venue operator really wants to know. Embodiments of the present invention recognize that dwell time is intended to identify customers who have stopped, or paused within a zone, thereby indicating that they are no longer traveling through the zone, and have switched to a different behavior.

Embodiments of the present invention recognize that such a change in behavior is often indicative of exploring the zone rather than merely passing through it. Embodiments of the present invention also recognize that the new behavior is exhibited for some specified amount of time. Embodiments of the present invention recognize the difficulties in computing or recognizing this change in behavior. Embodiments of the present invention recognize that due to the difficulties associated with identifying such changes in behavior, the “dwell time” for zones in known solutions are typically static values that are manually entered by the venue operator for each zone. Embodiments of the present invention recognize that this approach consumes increasing amounts of resources, such as hours of the operator's time, as the size of the venue increases, and generally results in the venue operator setting a universal dwell value for all zones in the venue to limit that resource consumption. Embodiments of the present invention provide computing or recognizing such changes in behavior.

Embodiments of the invention provide for dynamically determining dwell times in a zone of a venue. Some embodiments of the invention facilitate the dynamic creation of dwell values that recognize behavior changes by venue customers for individual zones, reduces the amount of resources required to configuring the venue while providing a variety of dwell times that are respectively associated with various zones in the venue. In accordance with an embodiment of the invention, different zones for a venue, such as a retail setting, are defined and a dwell time for each different zone in the venue is determined dynamically, based upon an empirical analysis of a respective an amount of foot traffic that is associated with a given zone. In accordance with an embodiment of the invention, the dwell time for each zone is periodically updated to account for contemporaneously observed foot traffic. In some such embodiments, and in certain scenarios, such periodic updates are leveraged to provide a more accurate customer path analysis.

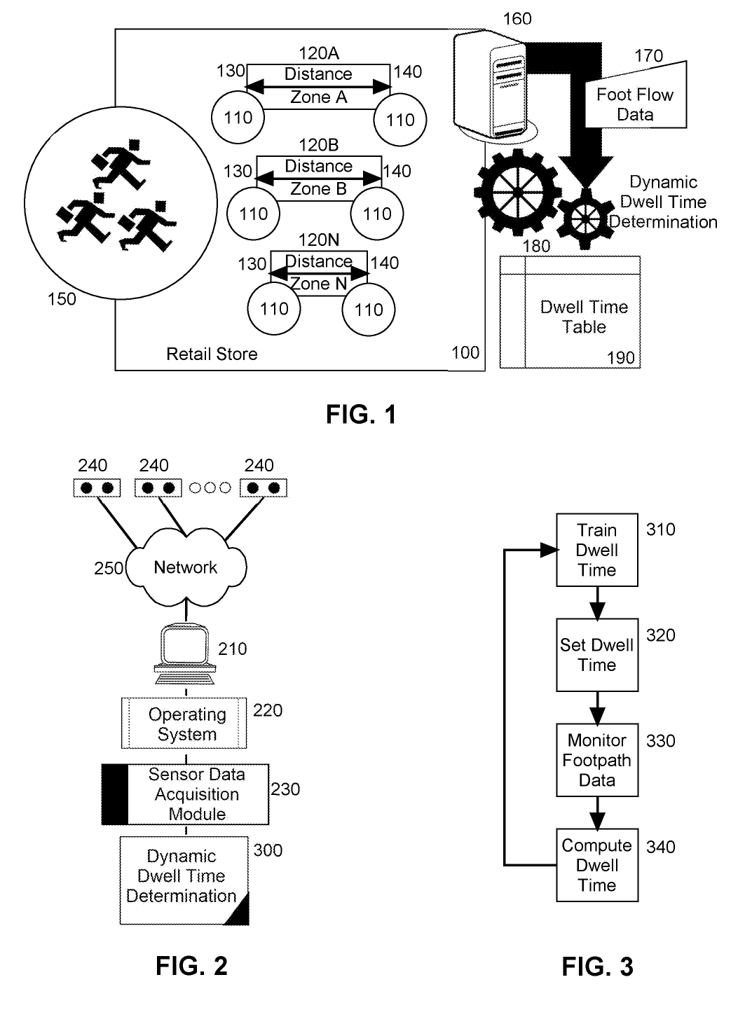

In further illustration, FIG. 1 pictorially shows a process for dynamically determining dwell times in a zone of a venue, for instance a retail setting. As shown in FIG. 1 a venue 100 such as a retail store is configured with multiple different zones 120A, 120B, 120N, for instance different shopping aisles. An entry point 130 is defined for each one of the zones 120A, 120B, 120N, and an exit point 140 is defined for each one of the zones 120A, 120B, 120N. As such, each of the different zones 120A, 120B, 120N has a particular length defined as a distance from the entry point 130 to the exit point 140. Finally, each of the different zones 120A, 120B, 120N is instrumented with different foot flow sensors 110 measuring a presence of an individual 150 when proximate to one of the foot flow sensors 110.

A server 160 hosting dynamic dwell time determination logic 180 is coupled to the different foot flow sensors 110 in the venue 100 and receives foot flow data 170 therefrom. In particular, the dynamic dwell time determination logic 180 maintains a dwell time table 190 in which different dwell times for different ones of the zones 120A, 120B, 120N are computed and then re-computed with respect to the received foot flow data 170. More particularly, the dynamic dwell time determination logic 180 initially establishes a dwell time in the dwell time table 190 for each of the zones 120A, 120B, 120N which includes a padding value, the initially established dwell time for each of the zones 120A, 120B, 120N reflecting an initial estimate of a duration of time during which each of the individuals 150 traverses a corresponding one of the zones 120A, 120B, 120N.

As one example, the initial estimate is computed by combining a known minimum time required for each of the individuals 150 to traverse a corresponding one of the different zones 120A, 120B, 120N, with a padding value that is a function of the minimum time. The minimum time itself is determined based upon a known distance from an entry point 130 of the corresponding one of the zones 120A, 120B, 120N to an exit point 140 of the corresponding one of the zones 120A, 120B, 120N, divided by a specified preferred walking speed of the individuals 150. Consequently, when one of the individuals 1150 exceeds the initial estimate by a threshold reflective in the padding value, that one of the individuals 150 is presumed to have transitioned from a traversing behavior to a dwelling behavior within the corresponding one of the zones 120A, 120B, 120N.

The dynamic dwell time determination logic 180 thereafter re-computes the dwell times for each of the zones 120A, 120B, 120N as the dynamic dwell time determination logic 180 receives foot flow data 170 from the different sensors 110. In this regard, a time taken by each of the individuals 150 to traverse a corresponding one of the zones 120A, 120B, 120N is determined from the foot flow data 170. The observed average times for the individuals 150 to traverse a corresponding one of the zones 120A, 120B, 120N is used to determine an average walking speed which in turn is then used to adjust the computed dwell time of the corresponding one of the zones 120A, 120B, 120N in respect to a distance from an entry point 130 to an exit point 140 of the corresponding one of the zones 120A, 120B, 120N.

The process described in connection with FIG. 1 may be implemented in a data processing system. In yet further illustration, FIG. 2 schematically shows a data processing system configured for dynamically determining dwell times in a zone of a retail setting. The system includes a host computing system 210 with one or more computers, each with memory and at least one processor. An operating system 220 executes in the host computing system 210 supporting and managing the operation of one or more different computer programs including a sensor data acquisition module 230. The sensor data acquisition module 230 operates to receive sensor data from one or more different sensors 240 communicatively coupled to the host computing system 210 from over computer communications network 250.

A dynamic dwell time determination module 300 also operates in connection with the operating system 220. The dynamic dwell time determination module 300 includes program code that when executes by the operating system 220 is enabled to establish different dwell times for different zones in a single venue instrumented with the sensors 240. The program code additionally is enabled to receive foot flow data from the sensors 240 for the different zones and to compute new ones of the dwell times for the different zones of the single venue based upon a measured time during which different individuals traverse each of the different zones of the single venue.

In even yet further illustration of the operation of the dynamic dwell time determination, FIG. 3 is a flow chart illustrating a process for dynamically determining dwell times in a zone of a retail setting. Beginning in block 310, initial dwell times are established for each zone in the venue. The initial dwell times may be established through a training process in which an amount of time to traverse each of the zones is measured through foot flow data acquired by the sensors. The foot flow data is translated into an average walking rate, e.g., distance per unit time. An entry point and exit point for each of the zones is then translated into a distance to be traversed in each zone. The average walking rate is combined with the distance to determine a minimum time to traverse each of the zones. Finally, a padding value based upon the minimum time is computed and added to the minimum time for each of the zones so as to establish the initial dwell time for each zone in block 320. In block 330, foot flow data is monitored for each of the zones. Thereafter, the dwell time for each of the zones is re-computed in block 340.

For example, a venue operator defines zones for a venue in a retail system that aggregates location data for different mobile devices in the venue. The venue operator then defines entry/exit sections of that zone. Thereafter, the dwell times for each zone in the venue are computed. Specifically, the dwell time is dynamically determined as the minimum travel time through a zone with padding. The minimum travel time through the zone is computed as the division of the preferred walking speed by the longest distance which is calculated by using the entry/exit sections of the zone to determine the longest path of travel. The padding in turn is calculated as a function of the “minimum travel time through the zone”. Thus, whereas the initial dwell time is computed as how long a customer remains in a zone in order to be considered “dwelling”, over time the dwell time reflects actual durations of time when a customer dwells in a zone.

The present invention may be embodied within a system, a method, a computer program product or any combination thereof. The computer program product may include a computer readable storage medium or media having computer readable program instructions thereon for causing a processor to carry out aspects of the present invention. The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing.

A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Finally, the terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

Having thus described the invention of the present application in detail and by reference to embodiments thereof, it will be apparent that modifications and variations are possible without departing from the scope of the invention defined in the appended claims as follows:

We claim:

1. A method for dynamically determining dwell times in a zone of a retail setting, comprising:
defining different zones of a retail setting in memory of a host computing system;
establishing a different dwell time for each of the different zones;
observing footfall in each of the different zones for different individuals in order to compute an actual dwell time for each individual in a particular one of the different zones; and,
re-establishing the different dwell time for each of the different zones based upon the observed footfall.

2. The method of claim 1, wherein the establishment of the different dwell time for each of the different zones comprises computing the different dwell time for each of the different zones during a training process in which footfall is observed in each of the different zones for different individuals in order to compute an initial dwell time for each individual in a particular one of the different zones.

3. The method of claim 1, wherein the dwell time for a corresponding one of the different zones is established initially by combining a known minimum time required for an individual to traverse a corresponding one of the different zones, with a padding value that is a function of the minimum time.

4. The method of claim 3, wherein the minimum time is determined based upon a known distance from an entry point of the corresponding one of the zones to an exit point of the corresponding one of the zones divided by a specified preferred walking speed of an individual.

5. The method of claim 4, wherein in response to a change by an operator in the host computing system of a location of the entry point and exit point of a corresponding one of the zones, the minimum time is re-determined.

6. A data processing system configured for dynamically determining dwell times in a zone of a retail setting, comprising:
a host computing system comprising one or more computers, each with memory and at least one processor;
an array of footfall sensors coupled to the host computing system and disposed at different positions in different zones of a retail setting; and,
a dynamic dwell time determination module executing in the memory of the host computing system, the module comprising program code enabled upon execution to define the different zones of the retail setting in the memory of the host computing system, to establish a different dwell time for each of the different zones, to observe footfall in each of the different zones for different individuals in order to compute an actual dwell time for each individual in a particular one of the different zones, and to re-establish the different dwell time for each of the different zones based upon the observed footfall.

7. The system of claim 6, wherein the establishment of the different dwell time for each of the different zones comprises computing the different dwell time for each of the different zones during a training process in which footfall is observed in each of the different zones for different individuals in order to compute an initial dwell time for each individual in a particular one of the different zones.

8. The system of claim 6, wherein the dwell time for a corresponding one of the different zones is established initially by combining a known minimum time required for an individual to traverse a corresponding one of the different zones, with a padding value that is a function of the minimum time.

9. The system of claim 8, wherein the minimum time is determined based upon a known distance from an entry point of the corresponding one of the zones to an exit point of the corresponding one of the zones divided by a specified preferred walking speed of an individual.

10. The system of claim 9, wherein in response to a change by an operator in the host computing system of a location of the entry point and exit point of a corresponding one of the zones, the minimum time is re-determined.

11. A computer program product for dynamically determining dwell times in a zone of a retail setting, the computer program product comprising a computer readable storage medium having program instructions embodied therewith, the program instructions executable by a device to cause the device to perform a method comprising:
defining different zones of a retail store in memory of a host computing system;
establishing a different dwell time for each of the different zones;
observing footfall in each of the different zones for different individuals in order to compute an actual dwell time for each individual in a particular one of the different zones; and,
re-establishing the different dwell time for each of the different zones based upon the observed footfall.

12. The computer program product of claim 11, wherein the establishment of the different dwell time for each of the different zones comprises computing the different dwell time for each of the different zones during a training process in which footfall is observed in each of the different zones for different individuals in order to compute an initial dwell time for each individual in a particular one of the different zones.

13. The computer program product of claim 11, wherein the dwell time for a corresponding one of the different zones is established initially by combining a known minimum time required for an individual to traverse a corresponding one of the different zones, with a padding value that is a function of the minimum time.

14. The computer program product of claim 13, wherein the minimum time is determined based upon a known distance from an entry point of the corresponding one of the zones to an exit point of the corresponding one of the zones divided by a specified preferred walking speed of an individual.

15. The computer program product of claim 14, wherein in response to a change by an operator in the host computing system of a location of the entry point and exit point of a corresponding one of the zones, the minimum time is re-determined.
